(19) United States
(12) Patent Application Publication
(10) Pub. No.: US 2025/0187025 A1
(43) Pub. Date: Jun. 12, 2025

(54) ELECTROSTATIC SPRAYING DEVICE

(71) Applicants: KAO CORPORATION, Tokyo (JP); PANASONIC HOLDINGS CORPORATION, Kadoma-shi (JP)

(72) Inventors: Hirokatsu SUGAWARA, Tokyo (JP); Ryo KOBAYASHI, Tokyo (JP); Hironobu HASHIZUME, Kadoma-shi (JP); Mitsuru FUJIWARA, Kadoma-shi (JP)

(73) Assignees: KAO CORPORATION, Tokyo (JP); PANASONIC HOLDINGS CORPORATION, Kadoma-shi (JP)

(21) Appl. No.: 18/845,557

(22) PCT Filed: Mar. 9, 2023
(86) PCT No.: PCT/JP2023/009136

§ 371 Date: Sep. 10, 2024

(30) Foreign Application Priority Data
Mar. 11, 2022 (JP) 2022-038304

(51) Int. Cl. B05B 5/16; B05B 5/035; B05B 5/053

(52) U.S. Cl. CPC B05B 5/1691; B05B 5/035; B05B 5/0533

(57) ABSTRACT

An electrostatic spraying device includes an electrostatic spraying main body configured to contain a liquid containing portion of a tubular cartridge having the liquid containing portion that contains a liquid and a nozzle for spraying the liquid. The electrostatic spraying main body includes a power source unit for supplying a voltage to the liquid, a containing space that contains the liquid containing portion, and a tubular housing internally having at least the power source unit and the containing space. The power source unit and the containing space are disposed at positions that do not overlap in a first direction of the housing and are disposed at positions where the power source unit and the containing space at least partially overlap in a second direction perpendicular to the first direction.

### FIELD

The present invention relates to an electrostatic spraying device.

### BACKGROUND

Conventionally, there has been known an electrostatic spraying device that sprays a liquid by an electrostatic force. For example, Patent Literatures 1 and 2 disclose electrostatic spraying devices that include high-voltage generators, batteries, and the like inside the electrostatic spraying devices and spray liquid compositions, which are electrostatically charged by high voltages from the high-voltage generators, toward objects from nozzles.

### CITATION LIST

### Patent Literature

Patent Literature 1: Japanese Unexamined Patent Application Publication No. 7-173031
Patent Literature 2: Japanese Patent No. 3384811

### SUMMARY OF INVENTION

### Technical Problem

In the electrostatic spraying device of Patent Literature 1, there has been a problem that the dimension of the device gets longer in a height direction because respective component parts, such as the high-voltage generator and the battery, are disposed along the height direction. On the other hand, in the electrostatic spraying device of Patent Literature 2, there has been a problem that the dimension of the device gets longer in a lateral direction because a part of the device to be gripped, the battery, and the like are disposed perpendicularly to a main body that contains the liquid composition.

The present invention relates to an electrostatic spraying device that allows the device to be downsized.

### Solution to Problem

An electrostatic spraying device according to the present invention includes an electrostatic spraying main body configured to contain a liquid containing portion of a tubular cartridge having the liquid containing portion that contains a liquid and a nozzle for spraying the liquid. The electrostatic spraying main body includes a power source unit for supplying a voltage to the liquid, a containing space that contains the liquid containing portion, and a tubular housing internally having at least the power source unit and the containing space. The power source unit and the containing space are disposed at positions that do not overlap in a first direction of the housing and are disposed at positions where the power source unit and the containing space at least partially overlap in a second direction perpendicular to the first direction.

An electrostatic spraying device according to the present invention includes a tubular cartridge and an electrostatic spraying main body. The tubular cartridge includes a liquid containing portion that contains a liquid and a nozzle for spraying the liquid. The electrostatic spraying main body is configured to contain the liquid containing portion of the cartridge. The electrostatic spraying main body includes a power source unit for supplying a voltage to the liquid, a containing space that contains the liquid containing portion, and a tubular housing internally having at least the power source unit and the containing space. The power source unit and the containing space are disposed at positions that do not overlap in a first direction of the housing and are disposed at positions where the power source unit and the containing space at least partially overlap in a second direction perpendicular to the first direction.

### Advantageous Effects of Invention

According to an electrostatic spraying device of the present invention, the device can be downsized.

### BRIEF DESCRIPTION OF DRAWINGS

FIG. 1 is a perspective view illustrating an electrostatic spraying device according to a first embodiment.

FIG. 2 is an exploded perspective view illustrating a state in which a cartridge according to the first embodiment is removed from an electrostatic spraying main body.

FIG. 3 is a left side cross-sectional side view illustrating the electrostatic spraying device according to the first embodiment.

FIG. 4 is a partially enlarged cross-sectional view illustrating the enlargement of a part of the cartridge according to the first embodiment.

FIG. 5 is a block configuration diagram illustrating a configuration included in a housing of the electrostatic spraying device according to the first embodiment.

FIG. 6 is a left side cross-sectional side view illustrating an electrostatic spraying device according to a second embodiment.

FIG. 7 is a partially enlarged cross-sectional view illustrating the enlargement of a part of the electrostatic spraying device according to the second embodiment.

FIG. 8 is a plane cross-sectional view illustrating the electrostatic spraying device according to the second embodiment.

FIG. 9 is a perspective view illustrating a rotation transmitting mechanism according to the second embodiment.

FIG. 10 is a drawing illustrating an exemplary control of a motor according to the second embodiment.

### DETAILED DESCRIPTION

Hereinafter, preferred embodiments for carrying out the present invention will be described by referring to the drawings. Note that, the following embodiments do not limit the present invention according to each of the claims, and all combinations of the characteristics described in the embodiments are not necessarily essential for means for solving the problems of the present invention. In addition, in the embodiments, the scale and dimensions of each component may be exaggerated, or some components may be omitted.

### [Overall Configuration and Operational Action of Electrostatic Spraying Device]

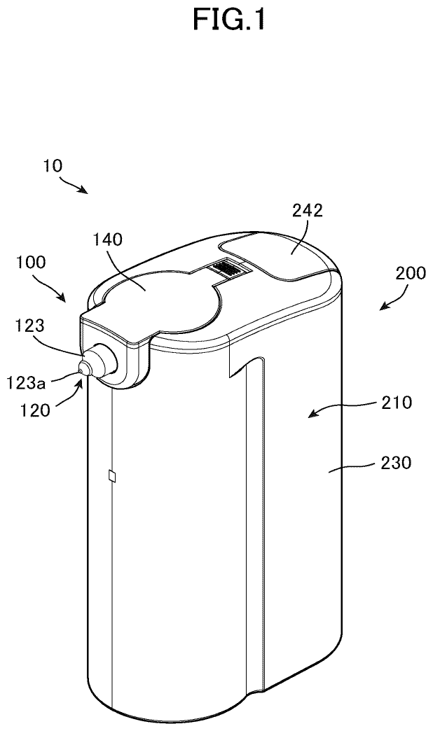

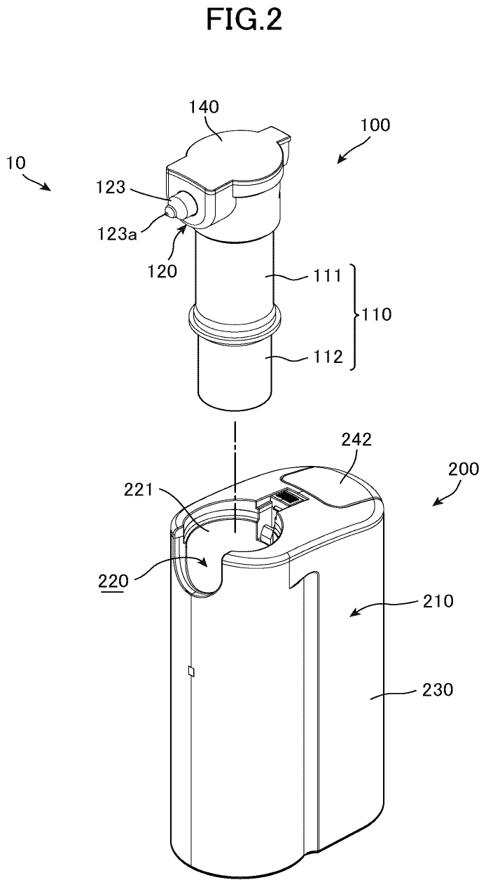

First, an electrostatic spraying device 10 according to a first embodiment will be described by referring to FIG. 1 to FIG. 5. As illustrated in FIG. 1 and FIG. 2, the electrostatic spraying device 10 according to the first embodiment includes a tubular cartridge 100 that contains a liquid, and an electrostatic spraying main body 200 into and from which the cartridge 100 is insertable and removable. In the first embodiment below, for the convenience of explanation, a direction in which the cartridge 100 is inserted into the electrostatic spraying main body 200 is defined as a lower side, and a direction in which the cartridge 100 is removed from the electrostatic spraying main body 200 is defined as an upper side to give an explanation. However, the up-down direction mentioned here is not necessarily the up-down direction in the actual usage condition.

The electrostatic spraying device 10 according to the first embodiment is a hand-held type device which has a shape and a size that can be gripped by a user with a hand, and sprays a liquid composition (the liquid) toward an object by an electrostatic spray method. The electrostatic spray method is a method in which a high voltage (for example, several kV to several dozen kV) is applied to a liquid composition (for example, a solution in which a high-molecular compound is dissolved in a volatile solvent) such that the liquid composition is electrostatically charged, and the liquid composition is sprayed toward an object by an electrostatic force based on a potential difference between the electrically charged liquid composition and the object. The liquid composition sprayed by the electrostatic spray method is sent toward the object in a mist form or an ultrafine thread form. In the sprayed liquid composition, the solvent that is a volatile substance is dried while the liquid composition is sprayed and then, is sent toward the object and after the liquid composition is attached to the object, and thus, a film can be formed on a surface of the object. Note that the electrostatic spraying device 10 according to the first embodiment can also be used as an electrostatic spinning device spraying a solution containing a raw material for electrostatic spinning, that is, a spinning liquid toward the object.

For example, in a case where a solution containing a volatile substance, a water-insoluble polymer for forming a fiber, and water is adopted as the liquid composition, the user grips the electrostatic spraying device 10 with the hand and sprays the liquid composition toward the skin of the user, thereby allowing a film to be formed on the surface of the skin of the user. The film is preferably a deposit containing a fiber.

Specifically, as the liquid composition of the spinning liquid used in an electrostatic spraying device or an electrostatic spinning device, for example, a solution in which a high-molecular compound configured to form a film, more preferably a high-molecular compound configured to form a fiber is dissolved in a solvent can be used. Any of a water-soluble high-molecular compound or a water-insoluble high-molecular compound can be used as the high-molecular compound. The high-molecular compound configured to form a fiber preferably contains a water-insoluble high-molecular compound.

When the water-insoluble high-molecular compound is used, the liquid composition contains 50 mass % or more volatile liquid agent selected from an alcohol and a ketone. The volatile liquid agent is a substance having volatility in a liquid state. A vapor pressure of the volatile liquid agent at 20° C. is preferably 0.01 kPa or more and 106.66 kPa or less, more preferably 0.13 kPa or more and 66.66 kPa or less, further preferably 0.67 kPa or more and 40.00 kPa or less, and even more preferably 1.33 kPa or more and 40.00 kPa or less.

Among the volatile liquid agents, for example, a monovalent chain aliphatic alcohol, a monovalent cyclic aliphatic alcohol, and a monovalent aromatic alcohol are preferably used as the alcohol. Examples of the monovalent chain aliphatic alcohol include C₁-C₆ alcohol, examples of the monovalent cyclic alcohol include C₄-C₆ cyclic alcohol, and examples of the monovalent aromatic alcohol include benzyl alcohol and phenylethyl alcohol. Specific examples thereof include ethanol, isopropyl alcohol, butyl alcohol, phenylethyl alcohol, n-propanol, and n-pentanol. One kind or two or more kinds selected from the alcohols can be used.

Among the volatile liquid agents, examples of the ketone include di-C₁-C₄ alkyl ketone, such as acetone, methyl ethyl ketone, and methyl isobutyl ketone. One kind of the ketones can be used alone, or two or more kinds of the ketones can be used in combination.

The volatile liquid agent is a volatile liquid agent more preferably containing one kind or two or more kinds selected from ethanol, isopropyl alcohol, and butyl alcohol, even more preferably containing one kind or two kinds selected from ethanol and butyl alcohol, and further preferably containing ethanol from the aspect of the touch of a fiber to be formed. An amount of the above-described volatile liquid agent contained is preferably 85 mass % or more, preferably 90 mass % or more, and preferably 100 mass % or less in the volatile liquid agent.

The contained amount of the volatile liquid agent in the liquid composition is preferably 50 mass % or more, more preferably 55 mass % or more, and further preferably 60 mass % or more. In addition, the contained amount is preferably 95 mass % or less, more preferably 94 mass % or less, and further preferably 93 mass % or less. The contained amount of the volatile liquid agent in the liquid composition is preferably 50 mass % or more and 95 mass % or less, more preferably 55 mass % or more and 94 mass % or less, and further preferably 60 mass % or more and 93 mass % or less. By containing the volatile liquid agent in the liquid composition at this proportion, the liquid composition can be sufficiently volatilized when the electrostatic spray method is performed, and a film containing a fiber can be formed on the surface of the skin or nail.

The ethanol is preferably 50 mass % or more, further preferably 65 mass % or more, and even more preferably 80 mass % or more, with respect to the total amount of the volatile liquid agent, from the aspect of high volatility and the touch of the fiber to be formed. In addition, the ethanol is preferably 100 mass % or less. The ethanol is preferably 50 mass % or more and 100 mass % or less, further preferably 65 mass % or more and 100 mass % or less, and even more preferably 80 mass % or more and 100 mass % or less, with respect to the total amount of the volatile liquid agent.

The liquid composition preferably contains a water-insoluble polymer for forming a fiber. The water-insoluble polymer for forming a fiber is a substance that can be dissolved in the volatile liquid agent. Here, dissolving means being in a dispersed state at 20° C. and the dispersed state being a visually homogeneous state, preferably, a visually transparent or semi-transparent state.

The water-insoluble polymer for forming a fiber is a polymer that is soluble in a volatile substance and insoluble in water. In the specification, a “water-soluble polymer” refers to a polymer having a property in which, after 1 g of the polymer is weighted and then dipped in 10 g of ion exchanged water in an environment of one atmosphere and 23° C., 0.5 g or more of the dipped polymer is dissolved in water after a lapse of 24 hours. On the other hand, in the specification, a “water-insoluble polymer” refers to a polymer having a property in which, after 1 g of the polymer is weighed and then dipped in 10 g of ion exchanged water in an environment of one atmosphere and 23° C., 0.5 g or more of the dipped polymer is not dissolved after a lapse of 24 hours, in other words, a polymer having a property in which the dissolution amount is less than 0.5 g.

Examples of the polymer that is insoluble in water and has fiber forming ability include, for example, completely saponified polyvinyl alcohol that can be subjected to an insoluble treatment after forming a film, partially saponified polyvinyl alcohol that can be subjected to a cross-linking treatment after forming a film by being used together with a cross-linking agent, oxazoline modified silicone, such as a poly(N-propanoyl ethylene imine) graft-dimethyl siloxane/γ-aminopropyl methyl siloxane copolymer, polyvinyl acetal diethyl aminoacetate, zein (a main component of corn protein), polyester, a polylactic acid (PLA), an acrylic resin, such as a polyacrylonitrile resin and a polymethacrylate resin, a polystyrene resin, a polyvinyl butyral resin, a polyethylene terephthalate resin, a polybutylene terephthalate resin, a polyurethane resin, a polyamide resin, a polyimide resin, and a polyamide imide resin. One kind selected from the water-insoluble polymers can be used, or two or more kinds can be used in combination. Among the water-insoluble polymers, it is preferable to use one kind or two or more kinds selected from the completely saponified polyvinyl alcohol that can be subjected to an insoluble treatment after forming a film, the partially saponified polyvinyl alcohol that can be subjected to a cross-linking treatment after forming a film by being used together with a cross-linking agent, the polyvinyl butyral resin, the polyurethane resin, the acrylic resin, such as a polymethacrylate resin, the polyvinyl acetal diethyl aminoacetate, the oxazoline modified silicone, such as a poly(N-propanoyl ethylene imine) graft-dimethyl siloxane/γ-aminopropyl methyl siloxane copolymer, the polylactic acid (PLA), and zein. Among the water-insoluble polymers, from the aspect of dispersibility to an alcohol solvent, the touch of the fiber, and the like, the partially saponified polyvinyl alcohol, the completely saponified polyvinyl alcohol, the polyvinyl butyral resin, the polymethacrylate resin, and the polyurethane resin are more preferred, and the partially saponified polyvinyl alcohol, the completely saponified polyvinyl alcohol, and the polyvinyl butyral resin are further preferred. From the aspect of being capable of stably and efficiently forming the film containing a fiber on the surface of the skin or the nail and from the aspect of durability of the film, forming properties of the film, and compatibility between followability with respect to the skin and the durability, the polyvinyl butyral resin is especially preferred.

An amount of the water-insoluble polymer for forming a fiber contained in the liquid composition is preferably 3 mass % or more, more preferably 4 mass % or more, and even more preferably 6 mass % or more. In addition, the contained amount is preferably 30 mass % or less, more preferably 25 mass % or less, and further preferably 20 mass % or less. The contained amount of the water-insoluble polymer for forming a fiber in the liquid composition is preferably 1 mass % or more and 30 mass % or less, further preferably 3 mass % or more and 25 mass % or less, and even more preferably 5 mass % or more and 20 mass % or less. By containing the water-insoluble polymer for forming a fiber in the liquid composition at this proportion, a fibrous film can be stably and efficiently formed.

The liquid composition may contain water. Since the water is ionized and charged compared to a solvent, such as ethanol, that is not ionized, or it dissolves ionic components to induce ionization, the water can impart conductivity to the liquid composition. Therefore, a fibrous film is stably formed on the surface of the skin or the nail by electrostatic spray. In addition, the water contributes to the improvement of the adhesiveness of a film to be formed by the electrostatic spray with respect to the skin or the nail, the improvement of the durability, and the appearance. From the aspect of obtaining the action effects, the water is preferably contained in the liquid composition at 0.2 mass % or more and 20 mass % or less, more preferably at 0.3 mass % or more and 15 mass % or less, and from the aspect of the forming properties of the fibrous film even in a humid environment, further preferably at 0.4 mass % or more and 10 mass % or less.

The liquid composition may further contain other components. Examples of the other components include, for example, polyols other than the above-described volatile liquid agents, oil that is liquid at 25° C., a plasticizer of the water-insoluble polymer for forming a fiber, an electroconductivity control agent of the liquid composition, a binder, a powder, such as a coloring pigment and an extender pigment, a colorant, a perfume, a repellent, an oxidant inhibitor, a stabilizer, an antiseptic agent, and various vitamins. In a case where the other components are contained in the liquid composition, a proportion of the other components contained is preferably 0.1 mass % or more and 30 mass % or less, and further preferably 0.5 mass % or more and 20 mass % or less.

A viscosity of the liquid composition at 25° C. is preferably 2 mPa·s or more and 3000 mPa·s or less, more preferably 10 mPa·s or more and 1500 mPa·s or less, further preferably 15 mPa·s or more and 1000 mPa·s or less, and even more preferably 15 mPa·s or more and 800 mPa·s or less, from the aspect of stably forming the fibrous film, from the aspect of spinnability at the time of performing the electrostatic spray, from the aspect of improving the durability of the film, and from the aspect of improving the touch of the film. The viscosity of the liquid composition is measured at 25° C. using an E-type viscosimeter. For example, an E-type viscosimeter (VISCONICEMD) manufactured by TOKYO KEIKI INC. can be used as the E-type viscosimeter. In that case, as measuring conditions, 25° C. is set, a cone-plate rotor No. 43 is used, and a suitable number of rotations according to the viscosity is selected as the number of rotations. The number of rotations is 5 rpm for the viscosity of 500 mPa·s or more, 10 rpm for the viscosity of 150 mPa·s or more and less than 500 mPa·s, and 20 rpm for the viscosity of less than 150 mPa·s.

### [Configuration of Cartridge]

The cartridge 100 is a disposable container to be exchangeably mounted on a device that is a supply object of the liquid, and a use application thereof is not particularly limited. However, in the first embodiment, the cartridge 100 is a cartridge for electrostatic spinning device that is used in an electrostatic spinning device. Specifically, as illustrated in FIG. 2 to FIG. 4, the cartridge 100 has a cylinder-type liquid containing portion 110 configured to contain the liquid composition, a spray unit 120 that is disposed on the liquid containing portion 110 and sprays the liquid composition in the liquid containing portion 110, a ring electrode 130 for supplying a voltage to a nozzle 123 described later of the spray unit 120, and a cover 140 that covers the liquid containing portion 110, the spray unit 120, and the ring electrode 130. The liquid containing portion 110, the spray unit 120, the ring electrode 130, and the cover 140 may be integrally formed or may be made of different members.

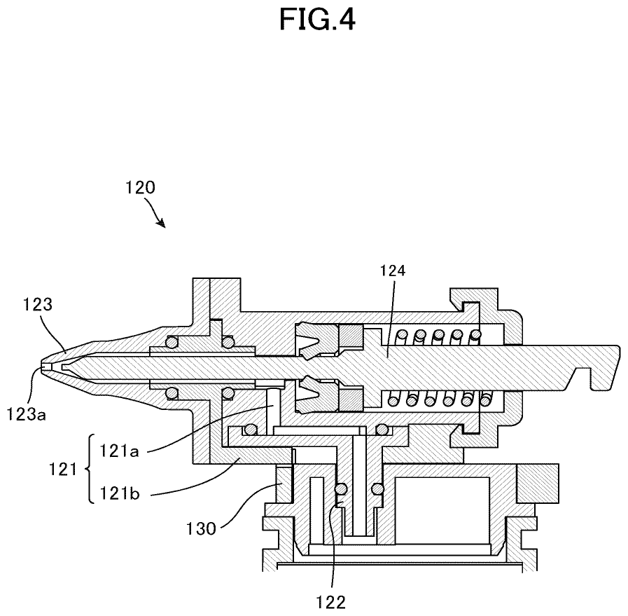

As illustrated in FIG. 4, the spray unit 120 has a mounting body 121, a connection body 122, the nozzle 123, and a shut-off pin 124. In the first embodiment, a part of the mounting body 121 is formed of a conductive resin (for example, a resin containing carbon). Note that the “conductive resin” refers to a resin that contains a conductive material, such as metal or carbon, has low electric resistance, and easily allows electricity to flow, and for example, refers to a resin having volume resistivity of less than or equal to 10⁻² Ωm. As the resin, for example, a resin having solvent resistance against a solvent of ethanol and the like, such as a polypropylene (PP) resin, polyethylene terephthalate (PET), a polyethylene (PE) resin, and a polyacetal (POM) resin can be adopted. The entire mounting body 121, or the mounting body 121 and the connection body 122 may be composed of a conductive resin.

The mounting body 121 has a flow path 121a and a small electrode 121b. The flow path 121a is a passage through which the liquid composition is distributed. The small electrode 121b is configured to electrostatically charge the liquid composition distributed inside the flow path in an additional manner. The connection body 122 is connected to the liquid containing portion 110 and communicated with the inside of the liquid containing portion 110, and is configured to guide the liquid composition in the liquid containing portion 110 to the flow path 121a of the mounting body 121. The nozzle 123 is connected to the mounting body 121, has a spray hole 123a at a tip, and has a linear nozzle flow path that connects the spray hole 123a and the flow path 121a of the mounting body 121. The nozzle 123 is configured to spray the liquid composition in the liquid containing portion 110 with the spray hole 123a. In the first embodiment, while the mounting body 121 is configured as a separate body from the connection body 122, the mounting body 121 and the connection body 122 may be integrally configured. In addition, while the nozzle 123 is configured as a separate body from the mounting body 121, the nozzle 123 and the mounting body 121 may be integrally configured.

The shut-off pin 124 is configured to be able to advance and retract along an axial direction of the nozzle 123 and configured to open and close the spray hole 123a of the nozzle 123. Note that the “axial direction of the nozzle 123” means an axis that passes through the center of the spray hole 123a of the nozzle 123 and lies along a liquid spraying direction. Specifically, the shut-off pin 124 is connected to an operation manipulation unit 242 described later at an end portion on an opposite side to the tip of the nozzle 123 and configured such that when the operation manipulation unit 242 is manipulated, the shut-off pin 124 retracts with respect to the tip of the nozzle 123 to open the spray hole 123a of the nozzle 123. In addition, the shut-off pin 124 is configured such that when the manipulation of the operation manipulation unit 242; is completed, the shut-off pin 124 moves to the tip side of the nozzle 123 to seal the spray hole 123a of the nozzle 123. Note that the shut-off pin 124 may be in a disposable form, similarly to the cartridge 100, or with only the cartridge 100 being disposable, the shut-off pin 124 may be in a repeatedly usable form.

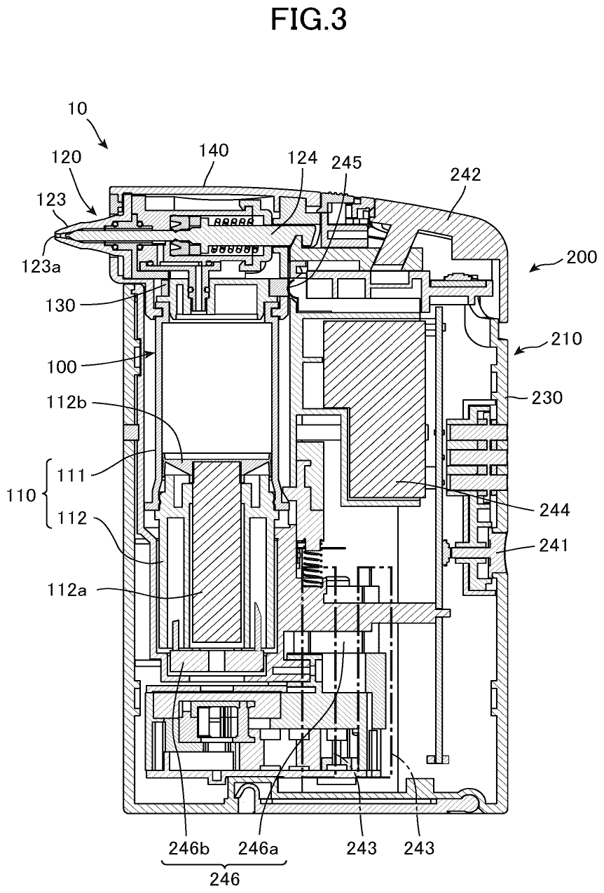

As illustrated in FIG. 2 and FIG. 3, the liquid containing portion 110 is disposed on the electrostatic spraying main body 200 side with respect to a direction along an axis of the nozzle 123. Specifically, the liquid containing portion 110 is disposed under the spray unit 120 and has a cylinder shape including a first tubular member 111 that can be connected to the spray unit 120 and a second tubular member 112 that is disposed under the first tubular member 111 and can be connected to the first tubular member 111. The liquid containing portion 110 is configured such that an axis of the liquid containing portion 110 (an axis along the up-down direction) is perpendicular to the axis of the nozzle 123. The first tubular member 111 is a cylindrical container and is configured to be able to contain the liquid composition. In addition, the first tubular member 111 is formed of a hard member and configured to avoid leakage of the liquid composition from the first tubular member 111 for reasons of damage to the container, the liquid oozing from the container, and the like. Here, it is only necessary for the hard member to be a material having a rigidity enough to keep the first tubular member 111 from being damaged when the electrostatic spraying device 10 is, for example, used and carried around, and for example, a plastic material and the like can be used.

The second tubular member 112 is a cylindrical container made of plastic and has a smaller diameter than the first tubular member 111. The second tubular member 112 is configured to rotate relative to the first tubular member 111 by a rotational force generated by driving a driving unit 246 described later. Inside the second tubular member 112, a piston rod 112a and a piston 112b provided at an end portion on the spray unit 120 side of the piston rod 112a are disposed.

The piston rod 112a is configured to be able to advance and retract in the axial direction by the rotation of the second tubular member 112 and configured to push up the piston 112b to the spray unit 120 side. Specifically, respective screws (not illustrated) that can mutually screw together are formed on an inner surface of the second tubular member 112 and an outer surface of the piston rod 112a, and the piston rod 112a is configured to screw forward to the spray unit 120 side by the rotation of the second tubular member 112. The piston 112b is configured to be able to advance and retract in the axial direction (the direction along the liquid containing portion 110) by the piston rod 112a and configured to be pushed up to the spray unit 120 side by the piston rod 112a to push out the liquid composition to the spray unit 120. Thus, in the first embodiment, the second tubular member 112, the piston rod 112a, and the piston 112b function as a linear motion mechanism for converting the rotational force of the driving unit 246 into a translatory movement to push out the liquid composition contained in the liquid containing portion 110 to the nozzle 123 side.

As illustrated in FIG. 4, the ring electrode 130 is disposed on the electrostatic spraying main body 200 side with respect to the direction along the axis of the nozzle 123. Specifically, the ring electrode 130 is disposed under the spray unit 120. In addition, the ring electrode 130 is disposed along a circumferential direction of the liquid containing portion 110 and configured to supply a voltage applied by a power source unit 243 described later to the nozzle 123 without passing through the liquid contained in the liquid containing portion 110. Specifically, the ring electrode 130 is disposed at an outer edge of an end portion on the spray unit 120 side of the liquid containing portion 110 in a ring shape. The ring electrode 130 is electrically connected to the small electrode 121b of the mounting body 121 on the nozzle 123 side and electrically connected to an output terminal 245 described later on an opposite side to the nozzle 123. That is, the voltage applied by the power source unit 243 described later is connected to the small electrode 121b of the mounting body 121 from the output terminal 245 described later via the ring electrode 130. In the first embodiment, the “ring shape” includes a semicircular shape or an approximately semicircular shape, in addition to a circular ring shape covering the entire outer edge of the end portion on the spray unit 120 side of the liquid containing portion 110. The ring electrode 130 preferably has a shape longer than 50% of a length in an outer peripheral direction of the liquid containing portion 110 and more preferably has a shape that is longer than 80% or more thereof from the aspect of securing the mounting ability of the ring electrode 130 with respect to the liquid containing portion 110, and further preferably has a circular ring shape from the aspect of improving contact performance to the output terminal 245.

Thus, since the ring electrode 130 is disposed at the outer edge of the end portion on the spray unit 120 side of the liquid containing portion 110, a voltage can be applied to the small electrode 121b without applying the voltage to the liquid composition contained in the liquid containing portion 110.

As illustrated in FIG. 2, the cover 140 is a cover that covers the end portion on the spray unit 120 side of the liquid containing portion 110, the mounting body 121 of the spray unit 120, the connection body 122, the shut-off pin 124, and the ring electrode 130. The cover 140 has openings at both end portions in the direction along the axis of the nozzle 123 and brings a state where the nozzle 123 projects out from one opening and the spray hole 123a is located outside the cover 140. From the other opening, the shut-off pin 124 can advance and retract along the axial direction of the nozzle 123. That is, the cover 140 is configured to allow the spray of the liquid composition from the spray unit 120 even in a case where the cover 140 is mounted on the liquid containing portion 110, the spray unit 120, and the ring electrode 130.

### [Configuration of Electrostatic Spraying Main Body]

As illustrated in FIG. 1 to FIG. 3 and FIG. 5, the electrostatic spraying main body 200 includes a housing 210 that internally contains each component, such as the power source unit 243.

### [External Structure of Housing]

As illustrated in FIG. 1 to FIG. 3, the housing 210 includes a containing space 220 that contains the liquid containing portion 110, an insertion hole 221 for inserting the liquid containing portion 110 into the containing space 220, a grip portion 230 configured to be gripped by a user, a main power source manipulation unit 241 that turns ON/OFF power supply the power source unit 243, and the operation manipulation unit 242 manipulated for spraying the liquid composition. The housing 210 has a shape and a size that can be gripped by the user with one hand as a whole. Specifically, the housing 210 is formed in a box shape (tubular shape having an upper surface and a lower surface) having an internal space in which the containing space 220 and a space for containing respective components, such as the power source unit 243, are separated from one another and has a cross-sectional surface perpendicular to an axial direction (a first direction and an up-down direction in FIG. 3) having an elliptical shape that has a long axis and a short axis. In addition, the housing 210 has a length in the direction along the axis of the nozzle 123 of, for example, 3 cm or more and 11 cm or less.

The housing 210 and the cover 140 described above are formed of an insulating material, that is, a material having a property of hardly conducting electricity. Note that, here, “insulating” “hardly conducting electricity” indicates, for example, having volume resistivity (ASTM D257, JIS K6911) of greater than 10¹² Ωm. Examples of the insulating material used for the housing 210 and the cover 140 include, for example, an insulating organic material, such as a synthetic resin, or an insulating inorganic material, such as glass or ceramic. As the insulating organic material, for example, polypropylene (PP), polyacetal, polyether ether ketone (PEEK), polytetrafluoroethylene (PTFE), monomer cast nylon, and the like can be used. On the other hand, a conductive material refers to a material having a property of easily conducting electricity, that is, a material having, for example, volume resistivity of less than or equal to 10⁻² Ωm.

As illustrated in FIG. 2 and FIG. 3, in the direction along the axis of the nozzle 123, on one end portion side of the housing 210 (an upper end portion side in FIG. 3), the insertion hole 221, through which the liquid containing portion 110 is insertable, is formed, and the containing space 220, which is communicated with the insertion hole 221 and contains the liquid containing portion 110, is formed. The insertion hole 221 and the containing space 220 are formed into a shape and a size that allows the liquid containing portion 110 to be inserted and removed.

The containing space 220 is formed along the axial direction of the housing 210 and is an opening space opening upward, which is formed by an inner wall of the housing 210 and a gear 246b of the driving unit 246 described later. In the first embodiment, the containing space 220 has been described as being formed along the axial direction of the housing 210, but this should not be construed in a limiting sense. The containing space 220 may be in a form that is formed along a direction oblique to the axial direction of the housing 210.

As illustrated in FIG. 2 and FIG. 3, the grip portion 230, the main power source manipulation unit 241, and the operation manipulation unit 242 are disposed on the other end portion side of the housing 210. Specifically, the grip portion 230, the main power source manipulation unit 241, and the operation manipulation unit 242 are disposed on a rear side in the liquid spraying direction with respect to the nozzle 123. The main power source manipulation unit 241 and the operation manipulation unit 242 are attached in a state where they can be manipulated from the outside of the housing 210. Specifically, the operation manipulation unit 242 is disposed at a corner portion at which an upper surface and a rear surface (surface on the rear side in the liquid spraying direction) of the housing 210 intersect, and the main power source manipulation unit 241 is disposed on the rear surface of the housing 210. In addition, the grip portion 230 is disposed on the lower side of the electrostatic spraying main body 200 with respect to the operation manipulation unit 242. The grip portion 230 is formed in a shape and a size that can be gripped by a user with one hand, and the power source unit 243 described later, a high-voltage generating unit 244, the output terminal 245, and a motor 246a of the driving unit 246 are disposed inside the grip portion 230.

### [Internal Structure and Operation of Housing]

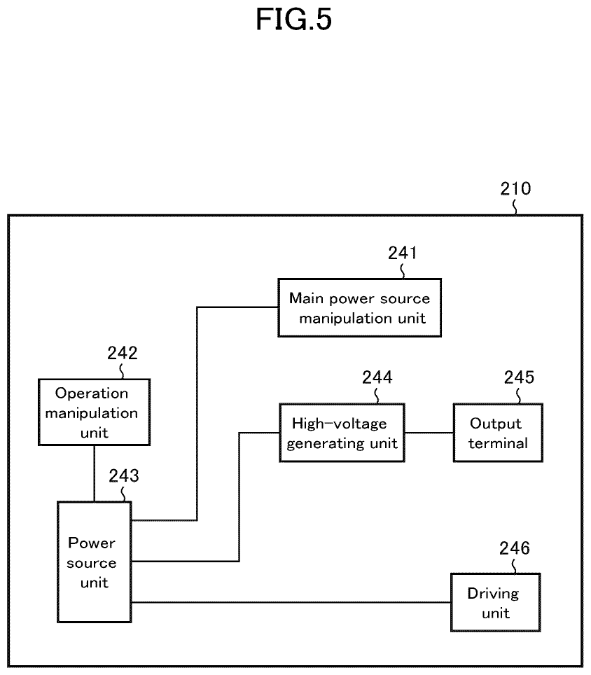

Next, the internal structure of the housing 210 will be described by referring to FIG. 3 and FIG. 5. The power source unit 243, the high-voltage generating unit 244, the output terminal 245, and the driving unit 246 are provided in the housing 210.

The power source unit 243 is a primary battery that is attachable and detachable with respect to the housing 210 and supplies power to each element in the housing 210. The power source unit 243 may be a secondary battery that is attachable and detachable or that is not attachable or detachable with respect to the housing 210. In addition, the power source unit 243 is disposed at a position that does not overlap with the containing space 220 in the axial direction of the housing 210 (the first direction) and disposed at a position where the power source unit 243 at least partially overlaps with the containing space 220 in a direction perpendicular to the axial direction of the housing 210 (a second direction). Specifically, the power source unit 243 is disposed such that an axial core of the power source unit 243 is parallel to the containing space 220 in the axial direction of the housing 210. More specifically, the power source unit 243 is disposed in parallel with the containing space 220 in the direction along the axis of the nozzle 123 and disposed on an opposite side to a spraying direction of the nozzle 123 with respect to the containing space 220. The power source unit 243 may be disposed such that the axial core of the power source unit 243 is vertical to the containing space 220.

As illustrated in FIG. 3 and FIG. 5, the driving unit 246 includes the motor 246a that generates a rotational force and the gear 246b (speed reduction transmitting mechanism) that transmits the rotation output from the motor 246a to a linear motion mechanism (second tubular member 112). The motor 246a is a motor for pushing out the liquid composition contained in the liquid containing portion 110 upward (the nozzle 123 side) and generates a rotational force when power is supplied by the power source unit 243. The rotational force is transmitted to the second tubular member 112 via the gear 246b.

The motor 246a is disposed at a position that does not overlap with the second tubular member 112 (linear motion mechanism) contained in the containing space 220 in the axial direction of the housing 210 and disposed at a position where the motor 246a at least partially overlaps with the second tubular member 112 (linear motion mechanism) in the direction perpendicular to the axial direction of the housing 210. Specifically, the motor 246a is configured such that an axial core of the motor 246a is parallel to the containing space 220 in the axial direction of the housing 210. More specifically, the motor 246a is disposed in parallel with the containing space 220 in the direction along the axis of the nozzle 123 and disposed on the opposite side to the spraying direction of the nozzle 123 with respect to the containing space 220. The motor 246a may be configured such that the axial core of the motor 246a is vertical to the containing space 220.

In addition, the motor 246a is disposed at a position that does not overlap with the power source unit 243 in the axial direction of the housing 210 and disposed at a position where the motor 246a at least partially overlaps with the power source unit 243 in the direction perpendicular to the axial direction of the housing 210. Specifically, the motor 246a is disposed in parallel with the power source unit 243 in a depth direction (a direction perpendicular to the axial direction of the housing 210 and the direction along the axis of the nozzle 123) in a side view of the housing 210 (in a state of FIG. 3).

The gear 246b is mechanically coupled to the second tubular member 112 under the liquid containing portion 110 (the opposite side to the nozzle 123) and is configured to transmit the rotational force generated by the motor 246a to the second tubular member 112 to rotate the second tubular member 112. In addition, the gear 246b includes a plurality of gears having different numbers of teeth and is configured to decelerate a speed reduction ratio of the motor 246a in multiple stages by engagement of the plurality of gears. In the first embodiment, the gear 246b is preferably configured such that the speed reduction ratio between a rotation speed of the second tubular member 112 and a rotation speed of the motor 246a is 1/50 to 1/5000 from the aspect of adjusting a sprayed amount and a spraying speed of the liquid composition, and is more preferably configured such that the speed reduction ratio is 1/300 to 1/3000 from the aspect of obtaining sufficient torque when the sprayed amount is set to be low and from the aspect of necessarily and sufficiently reducing the speed reduction ratio of the gear 246b.

In the first embodiment, the rotation speed of the motor 246a has been described as being adjusted by the gear 246b, but this should not be construed in a limiting sense. The rotation speed and rotation angle of the motor 246a may be in a form of being decelerated and controlled by power control. In this case, as the motor 246a, for example, a stepping motor that can control positioning, a servo motor that can detect a state of the motor by feedback, or the like can be adopted. By adopting a stepping motor, a servo motor, or the like, a space for the gear 246b can be reduced, and the number of components in the housing 210 can be reduced, therefore allowing the motor 246a to be directly connected to the liquid containing portion 110. As a result, simplification of the structure and downsizing of the device can be achieved.

Next, an operation performed by manipulating the main power source manipulation unit 241 and the operation manipulation unit 242 will be described. When the cartridge 100 is contained in the containing space 220 of the housing 210, the output terminal 245 is electrically connected to the small electrode 121b included inside the mounting body 121 of the cartridge 100 via the ring electrode 130 provided in the cartridge 100. In addition, the gear 246b of the driving unit 246 is mechanically coupled to the second tubular member 112 included in the cartridge 100.

When the main power source manipulation unit 241 is kept off (OFF), the power is not supplied to the high-voltage generating unit 244 or the driving unit 246 from the power source unit 243. In view of this, a high voltage is not generated from the high-voltage generating unit 244, or the driving unit 246 is not driven. Therefore, as long as the main power source manipulation unit 241 is kept OFF, the liquid composition d containing portion 110 is not electrostatically charged and the liquid composition is not sprayed even when a user mistakenly manipulates the operation manipulation unit 242.

The operation manipulation unit 242 is composed of, for example, a switch that can switch between an on (ON) state and an off (OFF) state.

When the operation manipulation unit 242 is turned ON while the main power source manipulation unit 241 is in the ON state, the power is supplied to the high-voltage generating unit 244 and the driving unit 246 from the power source unit 243. Then, the motor 246a of the driving unit 246 is driven to generate a rotational force, and the rotational force is transmitted to the second tubular member 112 included in the cartridge 100 via the gear 246b of the driving unit 246 to rotate the second tubular member 112. The rotation of the second tubular member 112 causes the piston rod 112a that screws with the inner surface of the second tubular member 112 to screw forward to the spray unit 120 side to push up the piston 112b to the spray unit 120 side and push out the liquid composition in the first tubular member 111 to the spray unit 120 side. The high-voltage generating unit 244 generates a positive high voltage (for example, several kV to several dozen kV) and sends the generated high voltage to the output terminal 245. The output terminal 245 sends the high voltage to the small electrode 121b included inside the mounting body 121 of the cartridge 100 via the ring electrode 130 provided in the cartridge 100. The small electrode 121b electrostatically charges the liquid composition distributed inside the cartridge 100 by the application of the high voltage.

When the liquid composition that is electrostatically charged as described above flows into the spray unit 120 from the liquid containing portion 110 and reaches the nozzle 123, the liquid composition is sprayed toward an object from the spray hole 123a of the nozzle 123 by the electrostatic force based on the potential difference between the electrically charged liquid composition and the object. Afterwards, when the operation manipulation unit 242 is turned OFF, the spray of the liquid composition is stopped.

In the housing 210, a selector switch (not illustrated) that can adjust the sprayed amount of the liquid composition in multiple stages (for example, two stages of large/small) or a switch for causing the liquid composition to reach the nozzle 123 without generating a high voltage may be provided in addition to the main power source manipulation unit 241 and the operation manipulation unit 242.

### Advantages of Electrostatic Spraying Device According to First Embodiment

Thus, the electrostatic spraying device 10 according to the first embodiment includes the liquid containing portion 110 that contains the liquid and the electrostatic spraying main body 200 configured to contain the liquid containing portion 110 of the tubular cartridge 100 having the nozzle 123 for spraying the liquid. The electrostatic spraying main body 200 includes the power source unit 243 for supplying a voltage to the liquid, the containing space 220 that contains the liquid containing portion 110, and the tubular housing 210 internally having at least the power source unit 243 and the containing space 220. The power source unit 243 and the containing space 220 are disposed at positions that do not overlap in the axial direction of the housing 210 (the first direction) and are disposed at positions where the power source unit 243 and the containing space 220 at least partially overlap in the direction perpendicular to the axial direction of the housing 210 (the second direction). Preferably, the power source unit 243 is disposed at a position along the containing space 220.

With the electrostatic spraying device 10 having the configuration, the power source unit 243 and the containing space 220 do not overlap in the axial direction of the housing 210. Therefore, the electrostatic spraying device 10 has the remarkable advantage that an increase in dimension in the axial direction of the housing 210 can be avoided, allowing the entire electrostatic spraying device 10 to be downsized.

In the electrostatic spraying device 10 according to the first embodiment, the cartridge 100 has the ring electrode 130 for supplying a voltage to the nozzle 123, and the liquid containing portion 110 is disposed on the nozzle 123 side with respect to the power source unit 243 and configured to be able to contain the ring electrode 130 of the cartridge 100. With the electrostatic spraying device 10 having the configuration, the ring electrode 130 is contained in the containing space 220 of the electrostatic spraying main body 200 in a state where the cartridge 100 is inserted into the electrostatic spraying main body 200, and the ring electrode 130 is not in contact with the outside of the electrostatic spraying main body 200. Therefore, the electrostatic spraying device 10 has the advantage that the risk of voltage leakage can be reduced, allowing the user to safely use the electrostatic spraying device 10. The ring electrode 130 is contained in the containing space 220 of the electrostatic spraying main body 200, eliminating the need to provide an unnecessary insulating member. Therefore, the electrostatic spraying device 10 also has the advantage that the entire device can be downsized. Furthermore, the electrostatic spraying device 10 also has the advantage that a voltage can be efficiently supplied through the shortest distance from the output terminal 245 provided in the electrostatic spraying main body 200 to the small electrode 121b of the mounting body 121 by containing the ring electrode 130 in the containing space 220 of the electrostatic spraying main body 200.

In addition, in the electrostatic spraying device 10 according to the first embodiment, the ring electrode 130 is disposed along the circumferential direction of the liquid containing portion 110 and is configured to supply a voltage applied by the power source unit 243 to the nozzle 123 without passing through the liquid contained in the liquid containing portion 110. The electrostatic spraying device 10 having the configuration eliminates the need to electrically charge the liquid contained in the liquid containing portion 110, therefore having the advantage of allowing a liquid seal structure of the liquid containing portion 110 to be simplified to reduce members for liquid leakage prevention to minimum.

Furthermore, in the electrostatic spraying device 10 according to the first embodiment, the electrostatic spraying main body 200 has the motor 246a that generates a rotational force and the linear motion mechanism (the second tubular member 112, the piston rod 112a, and the piston 112b) for converting the rotational force of the motor 246a into a translatory movement to push out the liquid contained in the liquid containing portion 110 to the nozzle 123 side. The motor 246a and the linear motion mechanism are disposed at positions that do not overlap in the axial direction of the housing 210 (the first direction) and are disposed at positions where the motor 246a and the linear motion mechanism at least partially overlap in the direction perpendicular to the axial direction of the housing 210 (the second direction). With the electrostatic spraying device 10 having the configuration, the motor 246a and the linear motion mechanism do not overlap in the axial direction of the housing 210. Therefore, the electrostatic spraying device 10 has the remarkable advantage that an increase in dimension in the axial direction of the housing 210 can be avoided, allowing the entire electrostatic spraying device 10 to be downsized.

In the electrostatic spraying device 10 according to the first embodiment, the axial core of an output shaft of the motor 246a is disposed to be parallel to an advancing and retracting direction of the linear motion mechanism. The electrostatic spraying device 10 having the configuration has the advantage of allowing the entire electrostatic spraying device 10 to be downsized because the axial core of the motor 246a is parallel to the linear motion mechanism.

Furthermore, in the electrostatic spraying device 10 according to the first embodiment, the axial core of the output shaft of the motor 246a is disposed to be vertical to the advancing and retracting direction of the linear motion mechanism. The electrostatic spraying device 10 having the configuration has the advantage that the rotational force of the motor 246a can be efficiently transmitted to the linear motion mechanism (second tubular member 112) because the output shaft of the motor 246a can be disposed at a position close to a connecting part of the linear motion mechanism (second tubular member 112).

Moreover, in the electrostatic spraying device 10 according to the first embodiment, the electrostatic spraying main body 200 further includes the speed reduction transmitting mechanism (gear 246b) that decelerates the rotation output from the motor 246a and transmits it to the linear motion mechanism. The electrostatic spraying device 10 having the configuration has the advantage that the sprayed amount and spraying speed of the liquid composition can be adjusted.

Furthermore, in the electrostatic spraying device 10 according to the first embodiment, the electrostatic spraying main body 200 has the operation manipulation unit 242 for controlling a spray operation of the liquid and the grip portion 230 for a user to grip. The operation manipulation unit 242 and the grip portion 230 are disposed on the rear side in the liquid spraying direction with respect to the nozzle 123, and the grip portion 230 is disposed on a downward side of the electrostatic spraying main body 200 with respect to the operation manipulation unit 242. The electrostatic spraying device 10 having the configuration has the advantage that the risk of electric shock can be reduced because the operation manipulation unit 242 and the grip portion 230 are located on the opposite side to the nozzle 123 in the liquid spraying direction. When a user grips the grip portion 230, the fingers of the user are spontaneously positioned on the operation manipulation unit 242 because the grip portion 230 is positioned on the downward side of the operation manipulation unit 242. Therefore, the electrostatic spraying device 10 also has the advantage that the operability of the electrostatic spraying device 10 can be improved.

In addition, in the electrostatic spraying device 10 according to the first embodiment, the liquid containing portion 110 is disposed on the electrostatic spraying main body 200 side with respect to the nozzle 123 with respect to the direction along the axis of the nozzle 123 and configured such that the axis of the liquid containing portion 110 is perpendicular to the axis of the nozzle 123. The containing space 220 is disposed on the nozzle 123 side with respect to the power source unit 243 in the second direction. With the electrostatic spraying device 10 having the configuration, the axis of the liquid containing portion 110 is configured to be perpendicular to the axis of the nozzle 123, and an increase in size of the housing 210 in the direction perpendicular to the first direction and the second direction can be avoided in a state where the liquid containing portion 110 is contained in the containing space 220. Therefore, the electrostatic spraying device 10 has the advantage of enabling the housing 210 to be firmly held during spray manipulation and facilitating the spray of the liquid composition to an object. Since the containing space 220 is disposed on the nozzle 123 side with respect to the power source unit 243 in the second direction, the flow path (the flow path 121a and the nozzle flow path) through which the liquid composition is distributed can be formed to be short. Therefore, the electrostatic spraying device 10 has the advantage that flow resistance when the liquid composition passes through the flow path can be reduced to keep a pressure in the container low, and a state where the liquid composition oozes from the nozzle 123 by a residual pressure in the flow path after the spray can be avoided.

### Second Embodiment

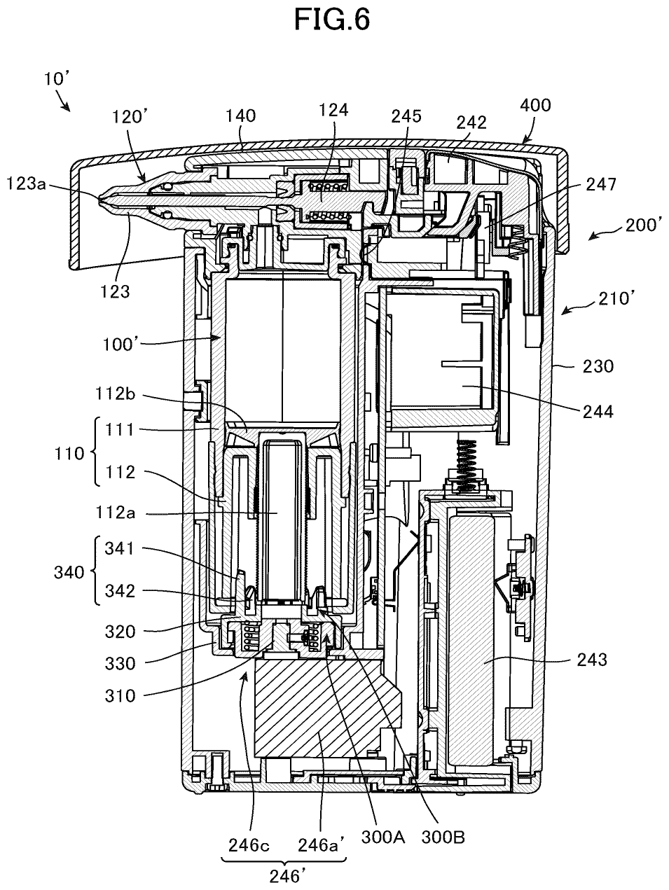

Next, an electrostatic spraying device 10′ according to a second embodiment will be described by referring to FIG. 6 to FIG. 9. As illustrated in FIG. 6 and FIG. 8, the electrostatic spraying device 10′ according to the second embodiment includes a tubular cartridge 100′ that contains a liquid composition, an electrostatic spraying main body 200′ into and from which the cartridge 100′ is insertable and removable, and a main body cap 400 that covers upper end portions of the cartridge 100′ and the electrostatic spraying main body 200′ (end portions on a side where the nozzle 123 is positioned in the first direction).

Note that in the electrostatic spraying device 10′ according to the second embodiment, configurations identical to those in the electrostatic spraying device 10 according to the first embodiment are denoted by the same reference numerals. In addition, in the electrostatic spraying device 10′ according to the second embodiment, a description of the configurations identical to those in the electrostatic spraying device 10 according to the first embodiment is omitted.

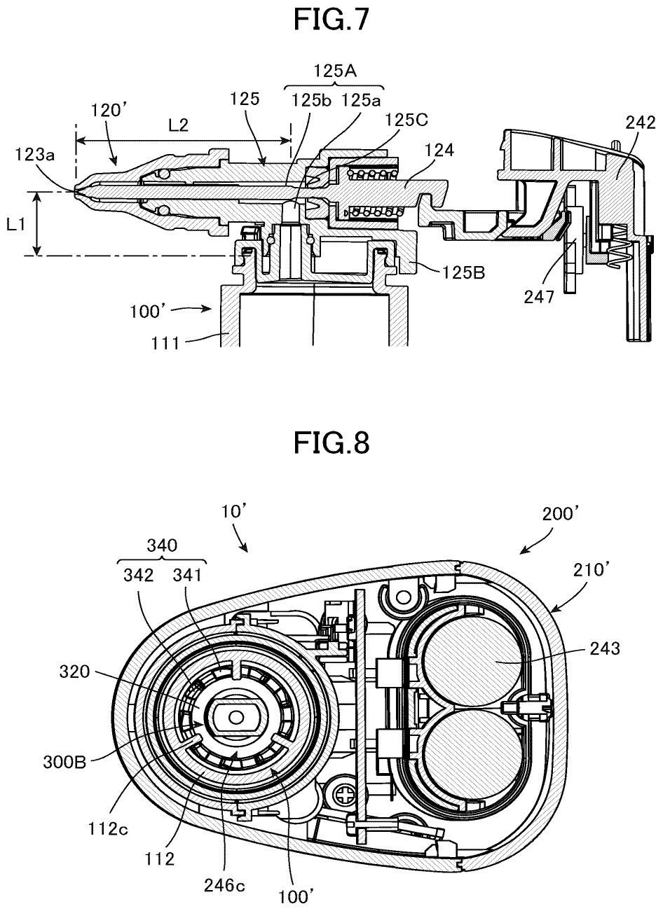

As illustrated in FIG. 6 and FIG. 7, the cartridge 100′ according to the second embodiment has the cylinder-type liquid containing portion 110 configured to contain the liquid composition, a spray unit 120′ that is disposed above the liquid containing portion 110 and sprays the liquid composition in the liquid containing portion 110, and the cover 140 that covers the liquid containing portion 110 and the spray unit 120′.

The second tubular member 112 of the liquid containing portion 110 has a plurality of ribs 112c on an inner surface of the second tubular member 112. The ribs 112c are provided to project toward an inner side from the inner surface of the second tubular member 112. In addition, the plurality of ribs 112c are provided at intervals (three at intervals of 120° in the second embodiment) in a circumferential direction of the second tubular member 112 (see FIG. 8).

The spray unit 120′ has the nozzle 123 for spraying the liquid composition, the shut-off pin 124 configured to advance and retract in a second internal flow path 125b described later, and a nozzle electrode 125 for supplying a voltage supplied from the power source unit 243 to the nozzle 123.

The nozzle electrode 125 has an internal flow path 125A for distributing the liquid composition contained in the liquid containing portion 110 to the nozzle 123 and a contact point portion 125B that is electrically connected to the output terminal 245. In the second embodiment, the nozzle electrode 125 is composed of a conductive resin as an integral body.

The internal flow path 125A has a first internal flow path 125a that extends along an axial direction of the liquid containing portion 110 and the second internal flow path 125b that is provided to bend from a tip of the first internal flow path 125a and extends along the axial direction of the nozzle 123. The first internal flow path 125a is communicated with the inside of the liquid containing portion 110, and the second internal flow path 125b is communicated with an inside of the nozzle 123. Specifically, the first internal flow path 125a is communicated with an inside of the first tubular member 111 of the liquid containing portion 110, and the second internal flow path 125b is communicated with the nozzle flow path of the nozzle 123.

The contact point portion 125B is configured to receive a voltage supplied from the power source unit 243 via the high-voltage generating unit 244 and the output terminal 245. In addition, on a cross-sectional view of the cartridge 100′ along the axial direction of the liquid containing portion 110 and the axial direction of the nozzle 123 (see FIG. 6 and FIG. 7), the contact point portion 125B is configured to be positioned on an outer side in a radial direction at an end portion on the spray unit 120′ side of the first tubular member 111 of the liquid containing portion 110 and at an end portion of the first tubular member 111 on an opposite side to the side where the nozzle 123 is positioned.

The nozzle electrode 125 has a through hole 125C through which the shut-off pin 124 is insertable at an end portion of the second internal flow path 125b on an opposite side to the side where the nozzle 123 is positioned. This allows the shut-off pin 124 to advance and retract in the second internal flow path 125b.

In the second embodiment, a ratio of a total flow path length of the internal flow path 125A and the nozzle flow path of the nozzle 123 to an average flow path diameter of the second internal flow path 125b and the nozzle flow path is preferably 5:1 or more, more preferably 8:1 or more, and most preferably 10:1 or more. Note that the total flow path length of the internal flow path 125A and the nozzle flow path of the nozzle 123 is a total flow path length of a flow path length L1 and a flow path length L2. The flow path length L1 ranges from an intersecting point of an axis of the first internal flow path 125a and an axis of the second internal flow path 125b to a base end (the end portion on the liquid containing portion 110 side) of the first internal flow path 125a. The flow path length L2 ranges from the intersecting point of the axis of the first internal flow path 125a and the axis of the second internal flow path 125b to the tip of the nozzle 123 (the tip of the nozzle flow path).

As illustrated in FIG. 6 to FIG. 8, the electrostatic spraying main body 200′ includes a housing 210′ that internally contains the power source unit 243, the high-voltage generating unit 244, the output terminal 245, a driving unit 246′, and a rotary dumper 247. The insertion hole 221 and the containing space 220 are formed on one end portion side in the second direction of the housing 210′. In addition, the grip portion 230 and the operation manipulation unit 242 are disposed on the other end portion side in the second direction of the housing 210′.

Similarly to the first embodiment, the power source unit 243 is disposed at a position that does not overlap with the containing space 220 in an axial direction of the housing 210′ (the first direction) and disposed at a position where the power source unit 243 at least partially overlaps with the containing space 220 in the direction perpendicular to the axial direction of the housing 210′ (the second direction) (see FIG. 6 and FIG. 8).

The driving unit 246′ includes a motor 246a′ that generates a rotational force and a rotation transmitting mechanism 246c that transmits the rotational force output from the motor 246a′ to the linear motion mechanism (second tubular member 112). In the second embodiment, the motor 246a′ is a stepping motor. Note that the motor 246a′ may be a servo motor.

The driving unit 246′ is configured to control the rotation direction, rotation speed, and rotation time of the motor 246a′. Specifically, the driving unit 246′ is configured to normally rotate (rotate to the right) the motor 246a′ at a first speed when the spray operation of the liquid composition is started (when the manipulation of the operation manipulation unit 242 is started) (first speed normal rotation period) and to normally rotate the motor 246a′ at a second speed slower than the first speed when a predetermined time t1 elapses from the state where the motor 246a′ is normally rotated at the first speed (second speed normal rotation period). In addition, the driving unit 246′ is configured to reversely rotate (rotate to the left) the motor 246a′ at a third speed faster than the second speed when the spray operation of the liquid composition is completed (when the manipulation of the operation manipulation unit 242 is completed) (third speed reverse rotation period) and to stop the motor 246a′ when a predetermined time t2 elapses from the state where the motor 246a′ is reversely rotated at the third speed.

In the second embodiment, the first speed is 7 rpm, the second speed is 0.6 rpm, and the third speed is 7 rpm. The time t1 is 1.6 seconds, and the time t2 is 1.7 seconds. The times t1 and t2 are predetermined times. Note that the rotation speed and rotation time of the motor 246a′ are not limited to them. For example, the first speed and the third speed may be different speeds, and the times t1 and t2 may be the same time.

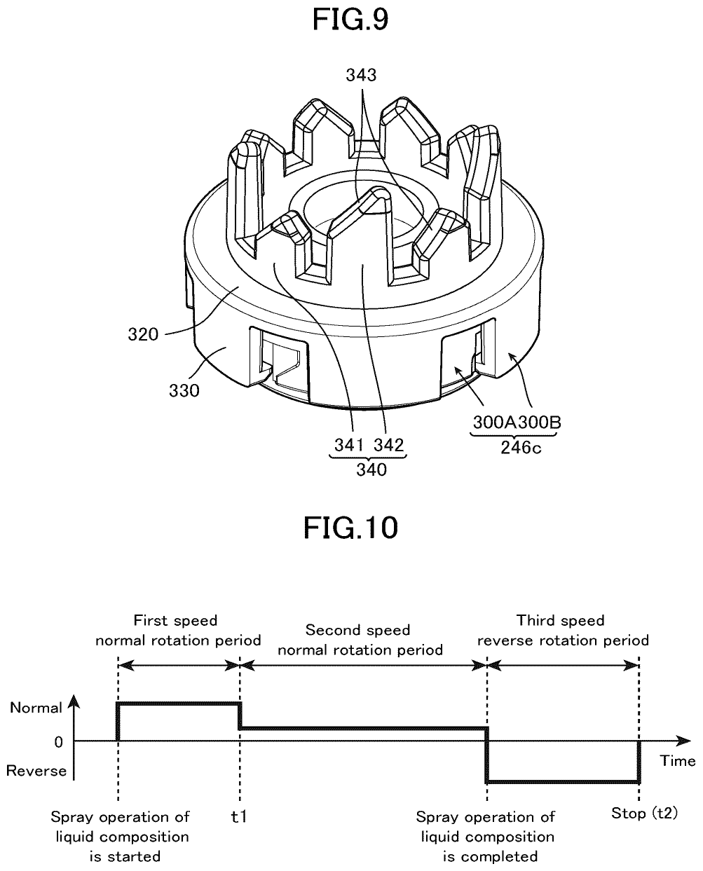

The motor 246a′ is disposed at a position where the motor 246a′ overlaps with the second tubular member 112 (linear motion mechanism) contained in the containing space 220 in the axial direction of the housing 210′ (the first direction). Specifically, the motor 246a′ is disposed below the liquid containing portion 110. The rotation transmitting mechanism 246c is disposed between the motor 246a′ and the liquid containing portion 110. As illustrated in FIG. 6, FIG. 8, and FIG. 9, the rotation transmitting mechanism 246c has a base body 300A coupled to the motor 246a′ and a cover body 300B that is mountable to the base body 300A and coupled to the second tubular member 112.

The base body 300A is formed in a columnar shape or an approximately columnar shape and has an inserting hole 310, through which a rotator of the motor 246a′ is insertable, at a center portion of the base body 300A. The inserting hole 310 is formed to penetrate from an upper surface of the base body 300A to a lower surface. The base body 300A is configured to be able to couple to the motor 246a′ by inserting the rotator of the motor 246a′ through inserting hole 310.

The cover body 300B has a circular base portion 320, a plurality of outer peripheral portions 330, and a plurality of tab portions 340. The base portion 320 has a diameter larger than an outer diameter of the base body 300A. The outer peripheral portions 330 extend downward (the opposite side to the second tubular member 112) from an outer edge of the base portion 320. The tab portions 340 are provided to project upward (the second tubular member 112 side) from an upper surface of the base portion 320 and form gaps into which the ribs 112c of the second tubular member 112 are insertable.

The plurality of tab portions 340 are provided at intervals (nine at intervals of 40° in the second embodiment) in a circumferential direction of the base portion 320. The tab portion 340 has a first tab portion 341 and a second tab portion 342 that differ in height from one another. The first tab portion 341 and the second tab portion 342 have inclined surfaces 343 that are inclined in a reverse rotation direction (left direction) of the motor 246a′.

The first tab portion 341 is formed higher than the second tab portion 342. In addition, the number of the first tab portions 341 provided is the same as the number of the ribs 112c of the second tubular member 112, and the first tab portions 341 are provided in an interval width different from an interval width of the ribs 112c. Specifically, the first tab portions 341 are provided in the interval width such that when the ribs 112c are inserted, any one first tab portion 341 of the plurality of first tab portions 341 comes into contact with the rib 112c and the other first tab portions 341 of the plurality of first tab portions 341 do not come into contact with the ribs 112c. In the second embodiment, three first tab portions 341 are provided at intervals of 80°.

The cover body 300B having the configuration is configured to be mountable to the base body 300A by fitting the base body 300A into a space formed by the base portion 320 and the outer peripheral portions 330. In addition, the cover body 300B is configured to be able to couple to the second tubular member 112 by inserting the ribs 112c of the second tubular member 112 into the gaps formed by the plurality of tab portions 340.

As described above, in the embodiment, the base body 300A and the cover body 300B are composed of separate members. In addition, a guide (not illustrated) is provided such that the base body 300A and the cover body 300B slide, and a spring (not illustrated) is provided between the base body 300A and the cover body 300B. This has the advantage of allowing smooth ejection of the cartridge 100′ in a state where the second tubular member 112 is coupled to the cover body 300B. Note that the base body 300A and the cover body 300B need not be separate members, and the base body 300A and the cover body 300B may be configured as an integral member. Forming the base body 300A and the cover body 300B as an integral member has the advantage of reducing play in the rotation direction and improving response.

The rotary dumper 247 is provided on a rear side of the shut-off pin 124 and on an inner side of the operation manipulation unit 242. In addition, the rotary dumper 247 is configured to reduce a moving speed of the shut-off pin 124 that moves to the tip side of the nozzle 123. Specifically, the moving speed of the rotary dumper 247 is preferably set such that the timing to seal the spray hole 123a of the nozzle 123 by the shut-off pin 124 is during the third speed reverse rotation period of the motor 246a′, and more preferably set such that the timing to seal the spray hole 123a of the nozzle 123 by the shut-off pin 124 is simultaneous with the completion of the third speed reverse rotation period of the motor 246a′.

As illustrated in FIG. 6, the main body cap 400 is configured to cover the nozzle 123 of the spray unit 120′, the cover 140, and the operation manipulation unit 242. In addition, the main body cap 400 is configured to be attachable and detachable with respect to the cartridge 100′ and the electrostatic spraying main body 200′. Therefore, when a user uses the electrostatic spraying device 10′, the main body cap 400 is removed. After the user uses the electrostatic spraying device 10′, the main body cap 400 is mounted. The electrostatic spraying device 10′ according to the second embodiment has the advantage of allowing the user to avoid manipulating the electrostatic spraying device 10′ unintentionally, that is, manipulating the operation manipulation unit 242, by including the main body cap 400. Therefore, the electrostatic spraying device 10′ also has the advantage of allowing the avoidance of the liquid being sprayed by manipulating the operation manipulation unit 242 unintentionally by the user and the liquid being dried by opening the spray hole 123a of the nozzle 123.

### Operation of Electrostatic Spraying Device According to Second Embodiment

Next, the operation of the electrostatic spraying device 10′ according to the second embodiment will be described. When the cartridge 100′ is contained in the containing space 220 of the housing 210′, the output terminal 245 is electrically connected to the nozzle electrode 125 provided in the cartridge 100′. The rotation transmitting mechanism 246c of the driving unit 246′ is mechanically coupled to the second tubular member 112 of the cartridge 100′. At this time, power is supplied to the high-voltage generating unit 244 and the driving unit 246′ from the power source unit 243.

Then, when the operation manipulation unit 242 is turned ON in a state where the main body cap 400 is removed, the shut-off pin 124 retracts with respect to the tip of the nozzle 123, and the motor 246a′ of the driving unit 246′ normally rotates at the first speed. This rotational force is transmitted to the second tubular member 112 via the rotation transmitting mechanism 246c of the driving unit 246′ to rotate the second tubular member 112. The rotation of the second tubular member 112 causes the piston rod 112a that screws with the inner surface of the second tubular member 112 to screw forward to the spray unit 120′ side to push up the piston 112b to the spray unit 120′ side and push out the liquid composition in the first tubular member 111 to the spray unit 120′ side.

The liquid composition pushed out to the spray unit 120′ side is distributed through the internal flow path 125A of the nozzle electrode 125 of the spray unit 120′. Since the nozzle electrode 125 is electrically connected to the high-voltage generating unit 244 via the output terminal 245, a positive high voltage generated by the high-voltage generating unit 244 (for example, several kV to several dozen kV) is applied to the nozzle electrode 125. This causes the liquid composition distributed through the internal flow path 125A to be electrostatically charged.

When the liquid composition that is electrostatically charged as described above flows into the spray unit 120′ from the liquid containing portion 110 and reaches the nozzle 123, the liquid composition is sprayed toward an object from the spray hole 123a of the nozzle 123 by the electrostatic force based on the potential e between the electrically charged liquid composition and the object. In the electrostatic spraying device 10′ according to the second embodiment, the motor 246a′ normally rotates at the second speed when the predetermined time t1 elapses from the state where the motor 246a′ normally rotates at the first speed.

When the operation manipulation unit 242 is turned OFF, the motor 246a′ reversely rotates at the third speed, and the shut-off pin 124 moves to the tip side of the nozzle 123 to seal the spray hole 123a of the nozzle 123. At this time, since the moving speed of the shut-off pin 124 is reduced by the rotary dumper 247, the shut-off pin 124 seals the spray hole 123a at least after the motor 246a′ starts to reversely rotate. In addition, the motor 246a′ stops when the predetermined time t2 elapses from the state where the motor 246a′ reversely rotates at the third speed. Then, the main body cap 400 is mounted again.

### Advantages of Electrostatic Spraying Device According to Second Embodiment

In the electrostatic spraying device 10′ according to the second embodiment, the cartridge 100′ has the nozzle electrode 125 for supplying a voltage to the nozzle 123. The nozzle electrode 125 has the internal flow path 125A for distributing the liquid contained in the liquid containing portion 110 to the nozzle 123. The internal flow path 125A has the first internal flow path 125a that extends along the axial direction of the liquid containing portion 110 and the second internal flow path 125b that is provided to bend from the tip of the first internal flow path 125a and extends along the axial direction of the nozzle 123. The first internal flow path 125a is communicated with the inside of the liquid containing portion 110, and the second internal flow path 125b is communicated with the inside of the nozzle 123. Unlike the electrostatic spraying device 10 according to the first embodiment, the electrostatic spraying device 10′ having the configuration has the advantage that the number of components can be reduced because the flow path and the electrode are configured as an integral body.

In the electrostatic spraying device 10′ according to the second embodiment, the ratio of the total flow path length of the internal flow path 125A and the nozzle flow path of the nozzle 123 to the average flow path diameter of the second internal flow path 125b and the nozzle flow path is 5:1 or more, and the motor 246a′ is a stepping motor. When the flow path is long, a state where the liquid composition remains in the flow path and a state where the liquid composition oozes from the nozzle 123 by a residual pressure in the flow path easily occur. However, the motor rotation speed, rotation direction, and rotation time can be controlled by adopting the stepping motor. Therefore, the electrostatic spraying device 10′ has the advantage of allowing the avoidance of the state where the liquid composition remains in the flow path and the state where the liquid composition oozes from the nozzle 123 by the residual pressure in the flow path.

Furthermore, in the electrostatic spraying device 10′ according to the second embodiment, the driving unit 246′ is configured to normally rotate the motor 246a′ at the first speed when the spray operation of the liquid composition is started, to normally rotate the motor 246a′ at the second speed slower than the first speed when the predetermined time t1 elapses from the state where the motor 246a′ is normally rotated at the first speed, and to reversely rotate the motor 246a′ at the third speed faster than the second speed when the spray operation of the liquid composition is completed. With the electrostatic spraying device 10′ having the configuration, when the spray operation by the electrostatic spraying device 10′ is completed, the motor 246a′ reversely rotates at the third speed faster than the second speed (reversely rotates at high speed), allowing the liquid composition remaining in the flow path to draw in. Therefore, the electrostatic spraying device 10′ has the advantage of allowing the avoidance of the state where the liquid composition remains in the flow path and the state where the liquid composition oozes from the nozzle 123 by the residual pressure in the flow path. When the spray operation by the electrostatic spraying device 10′ is started, the motor 246a′ normally rotates at the first speed faster than the second speed (normally rotates at high speed), allowing the liquid composition drawn in by the reverse rotation of the motor 246a′ at high speed to be pushed out. Therefore, the electrostatic spraying device 10′ has the advantage that appropriate spray can be performed.

In the electrostatic spraying device 10′ according to the second embodiment, the electrostatic spraying main body 200′ has the rotary dumper 247 that reduces the moving speed of the shut-off pin 124 that moves to the tip side of the nozzle 123. With the electrostatic spraying device 10′ having the configuration, when the spray operation by the electrostatic spraying device 10′ is completed, the rotary dumper 247 reduces the moving speed of the shut-off pin 124. Therefore, the electrostatic spraying device 10′ has the advantage of allowing the avoidance of the shut-off pin 124 sealing the spray hole 123a of the nozzle 123 before the motor 246a′ starts to reversely rotate.

Furthermore, in the electrostatic spraying device 10′ according to the second embodiment, the liquid containing portion 110 internally has the plurality of ribs 112c provided at intervals in the circumferential direction of the liquid containing portion 110. The electrostatic spraying main body 200′ has the rotation transmitting mechanism 246c that transmits the rotational force output from the motor 246a′ to the linear motion mechanism (second tubular member 112). The rotation transmitting mechanism 246c has the plurality of tab portions 340 that are provided to project toward the linear motion mechanism side and form gaps into which the ribs 112c are insertable. The tab portions 340 have the inclined surfaces 343 that are inclined in the reverse rotation direction of the motor 246a′. With the electrostatic spraying the device 10′ having configuration, all the ribs 112c are inserted to the reverse rotation direction side of the motor 246a′ in the tab portions 340. Therefore, the electrostatic spraying device 10′ has the advantage of allowing the avoidance of the rotation of the rotation transmitting mechanism 246c and the liquid containing portion 110 being restricted by inserting the respective ribs 112c into the normal rotation side and the reverse rotation direction side of the motor 246a′ in the tab portions 340.

In the electrostatic spraying device 10′ according to the second embodiment, the tab portion 340 has the first tab portion 341 and the second tab portion 342 that differ in height from one another. The first tab portion 341 is formed higher than the second tab portion 342. The number of the first tab portions 341 provided is the same as the number of the ribs 112c, and the first tab portions 341 are provided in the interval width such that when the ribs 112c are inserted, any one first tab portion 341 of the plurality of first tab portions 341 comes into contact with the rib 112c and the other first tab portions 341 of the plurality of first tab portions 341 do not come into contact with the ribs 112c. With the electrostatic spraying device 10′ having the configuration, the insertion of the ribs 112c to the reverse rotation direction side of the motor 246a′ in the first tab portions 341 is constantly performed by one first tab portion 341. Therefore, the electrostatic spraying device 10′ has the advantage that the insertion of the ribs 112c can be smoothly performed.

### [Modification]

The electrostatic spraying device according to the present invention is not limited to the embodiments described above, and various modifications can be made within the scope that does not deviate from the technical idea of the present invention.

For example, in the embodiment, the liquid composition has been described as being supplied to the flow path 121a of the mounting body 121 via the connection body 122 by the piston 112b being pushed up to the spray unit 120 side by the piston rod 112a, but this should not be construed in a limiting sense. Various arbitrary configurations, such as a configuration in which the liquid composition is sucked up by a piston pump, can be adopted.

In addition, in the embodiment, the voltage applied by the power source unit 243 has been described as being supplied to the nozzle 123 without passing through the liquid contained in the liquid containing portion 110, but this should not be construed in a limiting sense. A form in which the liquid composition is electrically charged in advance may be used.

Furthermore, in the embodiment, the motor 246a has been described as being disposed in parallel with the power source unit 243 in the depth direction in the side view of the housing 210, but this should not be construed in a limiting sense. For example, the motor 246a and the power source unit 243 may be configured to be disposed in parallel in a width direction in the side view of the housing 210 or may be configured to be disposed in series along the axis of the nozzle 123.

Moreover, in the embodiment, the cartridge 100 has been described as being configured to be insertable and removable with respect to the electrostatic spraying main body 200, but this should not be construed in a limiting sense. For example, the cartridge 100 may be configured such that the spray unit 120, the ring electrode 130, and the cover 140 of the cartridge 100 are fixed to the electrostatic spraying main body 200, and only the liquid containing portion 110 containing the liquid composition is attachable and detachable with respect to the electrostatic spraying main body 200.

It is apparent from the description of the claims that the modifications as described above are included in the scope of the present invention.

Regarding the above-described embodiments, the present invention further discloses the following electrostatic spraying device.

<1>

An electrostatic spraying device comprising
an electrostatic spraying main body configured to contain a liquid containing portion of a tubular cartridge having the liquid containing portion that contains a liquid and a nozzle for spraying the liquid,
in which the electrostatic spraying main body includes a power source unit for supplying a voltage to the liquid, a containing space that contains the liquid containing portion, and a tubular housing internally having at least the power source unit and the containing space, and
the power source unit and the containing space are disposed at positions that do not overlap in a first direction of the housing and are disposed at positions where the power source unit and the containing space at least partially overlap in a second direction perpendicular to the first direction.
   <2>

An electrostatic spraying device comprising:
a tubular cartridge having a liquid containing portion that contains a liquid and a nozzle for spraying the liquid; and
an electrostatic spraying main body configured to contain the liquid containing portion of the cartridge,
in which the electrostatic spraying main body includes a power source unit for supplying a voltage to the liquid, a containing space that contains the liquid containing portion, and a tubular housing internally having at least the power source unit and the containing space, and
the power source unit and the containing space are disposed at positions that do not overlap in a first direction of the housing and are disposed at positions where the power source unit and the containing space at least partially overlap in a second direction perpendicular to the first direction.
   <3>

The electrostatic spraying device according to <2>,
in which the liquid containing portion is disposed on the electrostatic spraying main body side with respect to the nozzle with respect to a direction along an axis of the nozzle,
an axis of the liquid containing portion is configured to be perpendicular to the axis of the nozzle, and
the containing space is disposed on the nozzle side with respect to the power source unit in the second direction.
   <4>

The electrostatic spraying device according to <2> or <3>,
in which the cartridge includes a ring electrode for supplying a voltage to the nozzle, and
the liquid containing portion is disposed on the nozzle side with respect to the power source unit and configured to be able to contain the ring electrode of the cartridge.
   <5>

The electrostatic spraying device according to <3>,
in which the ring electrode is disposed along a circumferential direction of the liquid containing portion and configured to supply a voltage applied by the power source unit to the nozzle without passing through the liquid contained in the liquid containing portion.
   <6>

The electrostatic spraying device according to any one of <2> to <5>,
in which the electrostatic spraying main body includes a motor that generates a rotational force, and
the cartridge includes a linear motion mechanism for converting the rotational force of the motor into a translatory movement to push out the liquid contained in the liquid containing portion to the nozzle side.
   <7>

The electrostatic spraying device according to <6>,
in which the motor and the linear motion mechanism are disposed at positions that do not overlap in the first direction and disposed at positions where the motor and the linear motion mechanism at least partially overlap in the second direction.
   <8>

The electrostatic spraying device according to <6> or <7>,
in which the motor is disposed such that an axial core of an output shaft of the motor is parallel to an advancing and retracting direction of the linear motion mechanism.
   <9>

The electrostatic spraying device according to <6> or <7>,
in which the motor is disposed such that an axial core of an output shaft of the motor is vertical to an advancing and retracting direction of the linear motion mechanism.
   <10>

The electrostatic spraying device according to any one of <6> to <9>,
in which the electrostatic spraying main body further includes a speed reduction transmitting mechanism that decelerates rotation output from the motor and transmits it to the linear motion mechanism.
   <11>

The electrostatic spraying device according to <10>,
in which the speed reduction transmitting mechanism has a plurality of gears having different numbers of teeth and is configured to decelerate a speed reduction ratio of the motor in multiple stages by engagement of the plurality of gears.
   <12>

The electrostatic spraying device according to any one of <6> to <9>,
in which the motor is a stepping motor or a servo motor.
   <13>

The electrostatic spraying device according to <2> or <3>,
in which the cartridge includes a nozzle electrode for supplying a voltage to the nozzle,
the nozzle electrode includes an internal flow path for distributing the liquid contained in the liquid containing portion to the nozzle,
the internal flow path has:
   a first internal flow path that extends along an axial direction of the liquid containing portion; and
   a second internal flow path that is provided to bend from a tip of the first internal flow path and extends along an axial direction of the nozzle,
the first internal flow path is communicated with an inside of the liquid containing portion, and
the second internal flow path is communicated with an inside of the nozzle.
   <14>

The electrostatic spraying device according to <13>,
in which the nozzle electrode is composed of a conductive resin as an integral body.
   <15>

The electrostatic spraying device according to <13> or <14>,
in which the nozzle electrode includes a contact point portion that receives a voltage supplied from the power source unit, and
the contact point portion is configured to be positioned at an end portion of the liquid containing portion on an opposite side to a side where the nozzle is positioned in the second direction.
   <16>

The electrostatic spraying device according to any one of <13> to <15>,
in which the electrostatic spraying main body includes a motor that generates a rotational force, and
the cartridge includes a linear motion mechanism for converting the rotational force of the motor into a translatory movement to push out the liquid contained in the liquid containing portion to the nozzle side.
   <17>

The electrostatic spraying device according to <16>,
in which the motor and the linear motion mechanism are disposed at positions where the motor and the linear motion mechanism overlap in the first direction.
   <18>

The electrostatic spraying device according to <16> or <17>,
in which the motor is a stepping motor or a servo motor.
   <19>

The electrostatic spraying device according to <18>,
in which a ratio of a total flow path length of the internal flow path and a nozzle flow path of the nozzle to an average flow path diameter of the second internal flow path and the nozzle flow path is 5:1 or more, and
the motor is a stepping motor.
   <20>

The electrostatic spraying device according to any one of <16> to <19>, comprising
a driving unit configured to normally rotate the motor at a first speed when a spray operation of a liquid is started, to normally rotate the motor at a second speed slower than the first speed when a predetermined time elapses from a state where the motor is normally rotated at the first speed, and to reversely rotate the motor at a third speed faster than the second speed when the spray operation of the liquid is completed.
   <21>

The electrostatic spraying device according to <20>,
in which the cartridge includes a shut-off pin configured to be able to advance and retract along the axial direction of the nozzle,
the shut-off pin is configured to retract with respect to a tip of the nozzle to open a spray hole of the nozzle when the spray operation of the liquid is started,
the shut-off pin is configured to move to the tip side of the nozzle to seal the spray hole when the spray operation of the liquid is completed, and
the electrostatic spraying main body includes a rotary dumper that reduces a moving speed of the shut-off pin that moves to the tip side of the nozzle.
   <22>

The electrostatic spraying device according to <21>,
in which the rotary damper is configured to reduce the moving speed of the shut-off pin such that the shut-off pin seals the spray hole at least after the motor starts to reversely rotate.
   <23>

The electrostatic spraying device according to any one of <16> to <22>,
in which the liquid containing portion internally has a plurality of ribs provided at intervals in circumferential direction of the liquid containing portion,
the electrostatic spraying main body includes a rotation transmitting mechanism that transmits a rotational force output from the motor to the linear motion mechanism,
the rotation transmitting mechanism has a plurality of tab portions that are provided to project toward the linear motion mechanism side and form gaps into which the ribs are insertable, and
the tab portion has an inclined surface that is inclined in a reverse rotation direction of the motor.
   <24>

The electrostatic spraying device according to <23>,
in which the tab portion has a first tab portion and a second tab portion that differ in height from one another,
the first tab portion is formed higher than the second tab portion, and
a number of the first tab portions provided is the same as a number of the ribs, and the first tab portions are provided in an interval width such that when the ribs are inserted, any one first tab portion of the plurality of first tab portions comes into contact with the rib and the other first tab portions of the plurality of first tab portions do not come into contact with the ribs.
   <25>

The electrostatic spraying devices according to <13> to <24>, further comprising
a main body cap that covers an end portion on a side where the nozzle is positioned in the first direction of the cartridge and the electrostatic spraying main body.
   <26>

The electrostatic spraying device according to any one of <1> to <25>,
in which the electrostatic spraying main body includes an operation manipulation unit for controlling a spray operation of the liquid and a grip portion for a user to grip,
the operation manipulation unit and the grip portion are disposed on a rear side in a liquid spraying direction with respect to the nozzle, and
the grip portion is disposed on a downward side of the electrostatic spraying main body with respect to the operation manipulation unit.
   <27>

The electrostatic spraying device according to <26>,
in which the operation manipulation unit is disposed at a corner portion at which an upper surface of the housing and a surface on a rear side in the liquid spraying direction of the housing intersect.
   <28>

The electrostatic spraying device according to any one of <1> to <27>,
in which the housing has a shape and a size configured to be gripped by a user with one hand.
   <29>

The electrostatic spraying device according to any one of <1> to <28>,
in which a member, which contains the liquid, in the liquid containing portion is formed of a hard member.
   <30>

The electrostatic spraying device according to any one of <1> to <29>,
in which the liquid contains a volatile substance, a water-insoluble polymer for forming a fiber, and water and forms a film as a deposit containing a fiber on a surface of skin of a user.

### DESCRIPTION OF REFERENCE NUMERAL

10, 10′ Electrostatic spraying device
100, 100′ Cartridge
110 Liquid containing portion
111 First tubular member
112 Second tubular member
112a Piston rod
112b Piston
112c Rib
120, 120′ Spray unit
121 Mounting body
121a Flow path
121b Small electrode
122 Connection body
123 Nozzle
123a Spray hole
124 Shut-off pin
125 Nozzle electrode
125A Internal flow path
125B Contact point portion
125C Through hole
125a First internal flow path
125b Second internal flow path
130 Ring electrode
140 Cover
200, 200′ Electrostatic spraying main body
210, 210′ Housing
220 Containing space
221 Insertion hole
230 Grip portion
241 Main power source manipulation unit
242 Operation manipulation unit
243 Power source unit
244 High-voltage generating unit
245 Output terminal
246, 246′ Driving unit
246a, 246a′ Motor
246b Gear
246c Rotation transmitting mechanism
247 Rotary dumper
300A Base body
300B Cover body
310 Inserting hole
320 Base portion
330 Outer peripheral portion
340 Tab portion
341 First tab portion
342 Second tab portion
343 Inclined surface
400 Main body cap

1. An electrostatic spraying device, comprising:
an electrostatic spraying main body configured to contain a liquid containing portion of a tubular cartridge having the liquid containing portion that contains a liquid and a nozzle for spraying the liquid,
wherein the electrostatic spraying main body comprises:
a power source unit for supplying a voltage to the liquid;
a containing space that contains the liquid containing portion; and
a tubular housing internally having at least the power source unit and the containing space, and
wherein the power source unit and the containing space are disposed at positions that do not overlap in a first direction of the housing and are disposed at positions where the power source unit and the containing space at least partially overlap in a second direction perpendicular to the first direction.

2. An electrostatic spraying device comprising:
a tubular cartridge having a liquid containing portion that contains a liquid and a nozzle for spraying the liquid; and
an electrostatic spraying main body configured to contain the liquid containing portion of the cartridge,
wherein the electrostatic spraying main body comprises:
a power source unit for supplying a voltage to the liquid;
a containing space that contains the liquid containing portion; and
a tubular housing internally having at least the power source unit and the containing space, and
wherein the power source unit and the containing space are disposed at positions that do not overlap in a first direction of the housing and are disposed at positions where the power source unit and the containing space at least partially overlap in a second direction perpendicular to the first direction.

3. The electrostatic spraying device of claim 2, wherein:
the liquid containing portion is disposed on the electrostatic spraying main body side with respect to the nozzle with respect to a direction along an axis of the nozzle,
an axis of the liquid containing portion is configured to be perpendicular to the axis of the nozzle, and
the containing space is disposed on the nozzle side with respect to the power source unit in the second direction.

4. The electrostatic spraying device of claim 2, wherein;
the liquid containing portion is disposed on the electrostatic spraying main body side with respect to the nozzle with respect to a direction along an axis of the nozzle,
an axis of the liquid containing portion is configured to be perpendicular to the axis of the nozzle, and
the containing space is disposed on the nozzle side with respect to the power source unit in the second direction.

5. The electrostatic spraying device of claim 2, wherein;
the electrostatic spraying main body includes a motor that generates a rotational force, and
the cartridge includes a linear motion mechanism for converting the rotational force of the motor into a translatory movement to push out the liquid contained in the liquid containing portion to the nozzle side.

6. The electrostatic spraying device of claim 5, wherein the motor is a stepping motor or a servo motor.

7. The electrostatic spraying device of claim 1, wherein
the electrostatic spraying main body includes an operation manipulation unit for controlling a spray operation of the liquid and a grip portion for a user to grip,
the operation manipulation unit and the grip portion are disposed on a rear side in a liquid spraying direction with respect to the nozzle, and
the grip portion is disposed on a downward side of the electrostatic spraying main body with respect to the operation manipulation unit.
